(19) United States
(12) Patent Application Publication
(10) Pub. No.: US 2011/0061607 A1
(43) Pub. Date: Mar. 17, 2011

(54) Device is a fabric pouch with a sleeve that slides over an animal/pet/dog's existing collar. The pouch holds cooling/warming medium like flexible manufactured ice cubes against the underside of the animal/pet/dog's neck to aid with body temperature regulation

(75) Inventor: Susan Marie Landrith, Boca Raton, FL (US)

(73) Assignee: Marleys Mates LLC, Cooper City, FL (US)

(21) Appl. No.: 12/882,098

(22) Filed: Sep. 14, 2010

Related U.S. Application Data
(60) Provisional application No. 61/242,904, filed on Sep. 16, 2009.

(51) Int. Cl. A01K 29/00

(52) U.S. Cl. 119/850

(57) ABSTRACT

The application of cold or warm applied directly to the underside of an animal/pet/dog's neck where blood vessels run close to the skin can aid in the cooling or warming of the pet/dog's body temperature thereby making the animal/pet/dog more comfortable in warmer/cooler temperatures. My invention creates an easy to use pouch that can hold a cooling or warming medium like manufactured ice cubes, gel or other medium, and slips over the animal/pet/dog's regular collar. This device enables the cooling or warming medium to stay securely against the underside of the animal/pet/dog's neck. This allows the coldness/warmth produced by the cooling/warming medium in the pouch to transfer to the animal/pet/dog's body, lowering the animal/pet/dog's body temperature making the pet/dog more comfortable in hot/cold temperatures.

### CROSS REFERENCE TO RELATED APPLICATIONS

This application is a regular utility patent application based on and claiming priority from a provisional application No. 61/242,904 filed on Sep. 16, 2009.

### TITLE OF INVENTION

The device is a fabric pouch with a sleeve that slides over an animal/pet/dog's existing collar. The pouch holds warming/cooling medium like flexible manufactured ice cubes, against the underside of an animal/pet/dog's neck to aid with body temperature regulation.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains generally to animal husbandry and/or pets generally.

Many animals are susceptible to exposure to extreme temperatures. For example, dog breeds with short noses can overheat very quickly in the summer heat just while taking a walk. Some large breeds will overexert themselves while playing outdoors in hot temperatures.

The underside of the neck of many animal/pets/dogs have blood vessels running close to the skin and offer one of the best places to apply a cold or hot medium to affect the body temperature of the animal/pet/dog. It is desirable to have a simple, easy to use system to apply cold or heat directly to that neck area remotely so it can easily be used during work, play or walking in extreme weather.

There are three devices that attempt to address this problem. All three have disadvantages that my device resolves. These disadvantages include dealing with melted ice and the resultant water deposit; collars that will either have to replace a pet/dog's existing collar that contains registration/identification tags that will need to be moved temporarily or, if the existing collar is left on the pet/dog, then the effectiveness of the cooling collar is diminished due to the interference of the position of the existing collar. Comfort to the animal/pet/dog is another consideration and the fact that these devices may be one-use items and need to be re-frozen.

One device uses a collar with absorbent crystals. The crystals absorb water and cools the animal as the water evaporates.

A second device is a scarf soaked in water and then refrigerated or frozen. This device is only effective until it thaws and then it must be re-frozen to be effective.

The third device is a chill collar that is a rigid plastic hollow body with an interior chamber that is filled with water and then frozen.

### SUMMARY

My device is a soft fabric pouch that holds cooling (i.e. flexible manufactured ice cubes) or warming medium against the underside of the animal/pet/dog's neck with a sleeve attached to the pouch. My system is easy to use while boating or camping and offers flexibility that other systems do not offer.

Extra flexible manufactured ice cubes can be kept in a cooler and replaced as necessary.

My device easily slides over the animal/pet/dog's existing collar which then holds the cooling/warming medium against the underside of the animal/pet/dog's neck. there is no need to remove registration/identification tags to use.

Fabric is soft and can be made to look fashionable with different fabrics and trim. Manufactured ice cubes do not sweat or leak when they thaw.

### DESCRIPTION OF THE SEVERAL VIEWS OF THE DRAWING

The device is comprised of the following:

Please refer to the drawings at the end of this example.

FIG. 1: 18 inch by 3 inch strip of fabric

FIG. 2: 7 inch by 3 inch strip of fabric

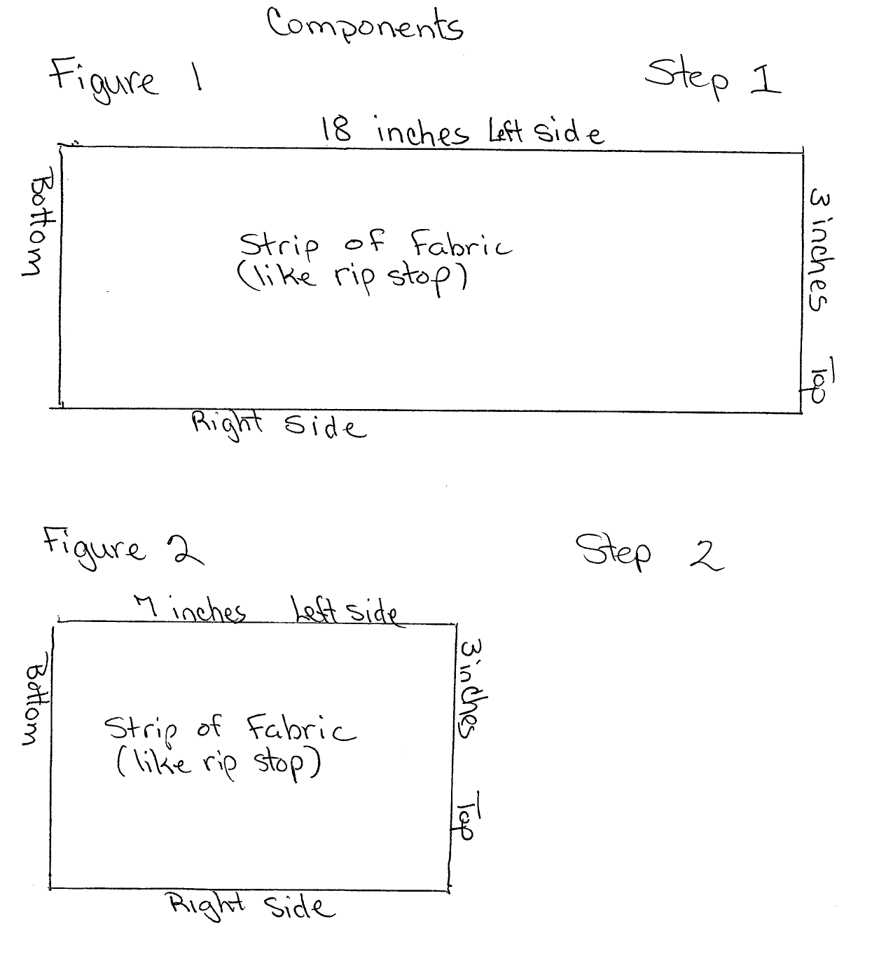

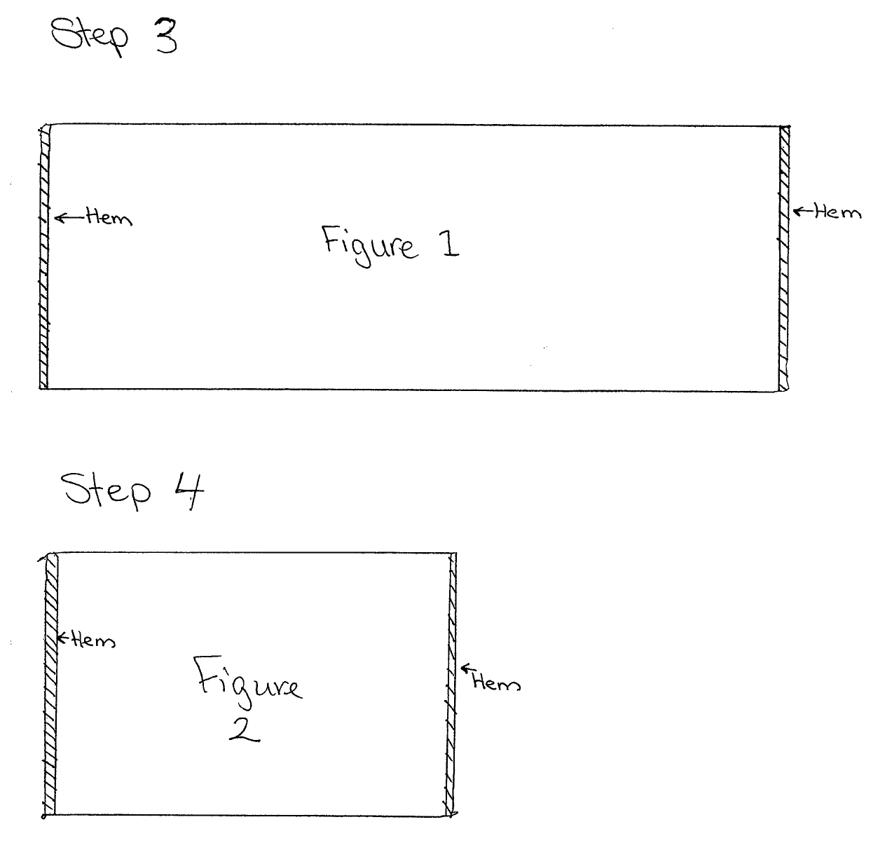

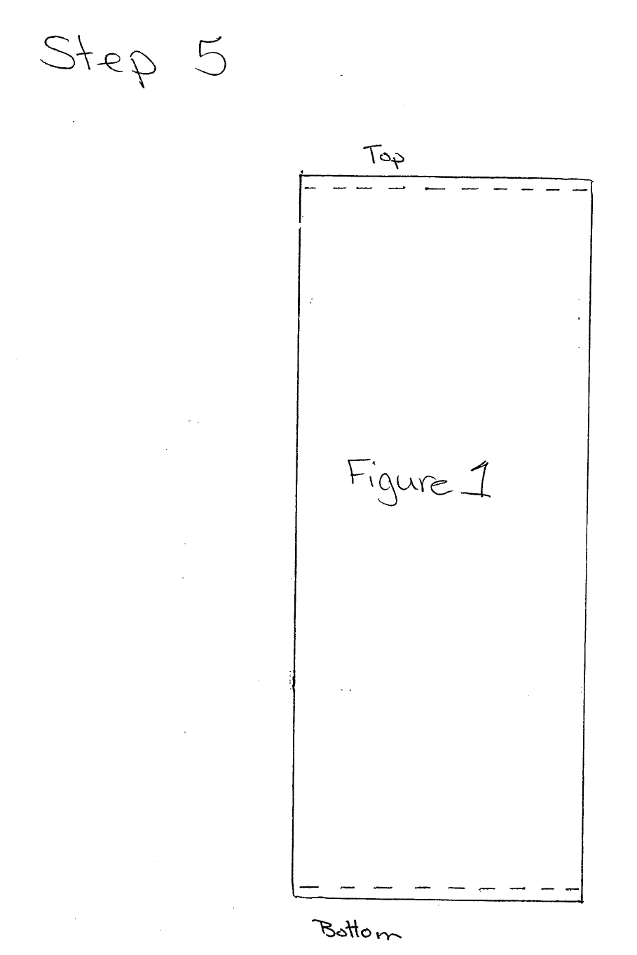

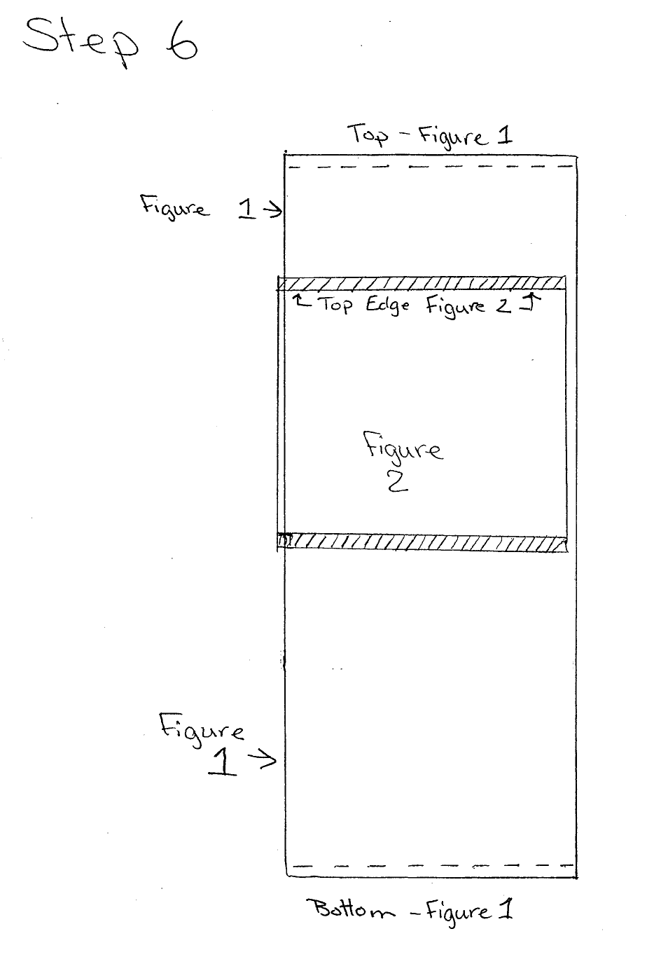

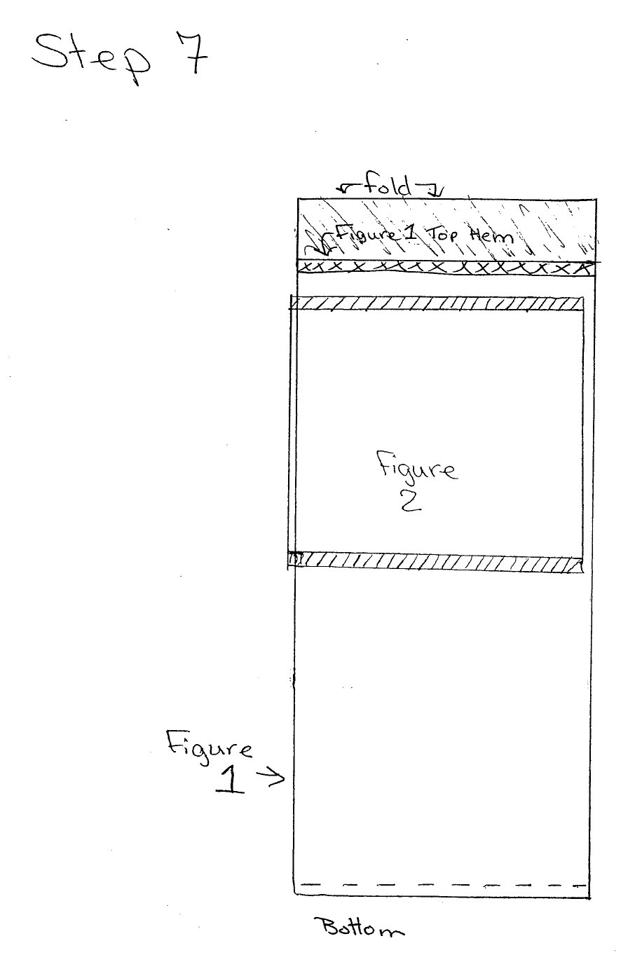

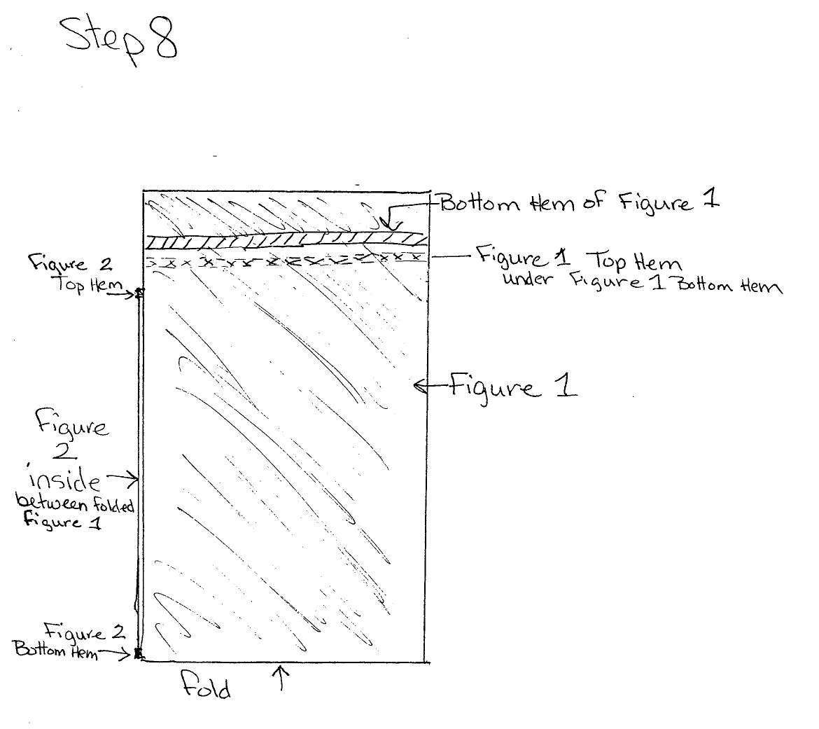

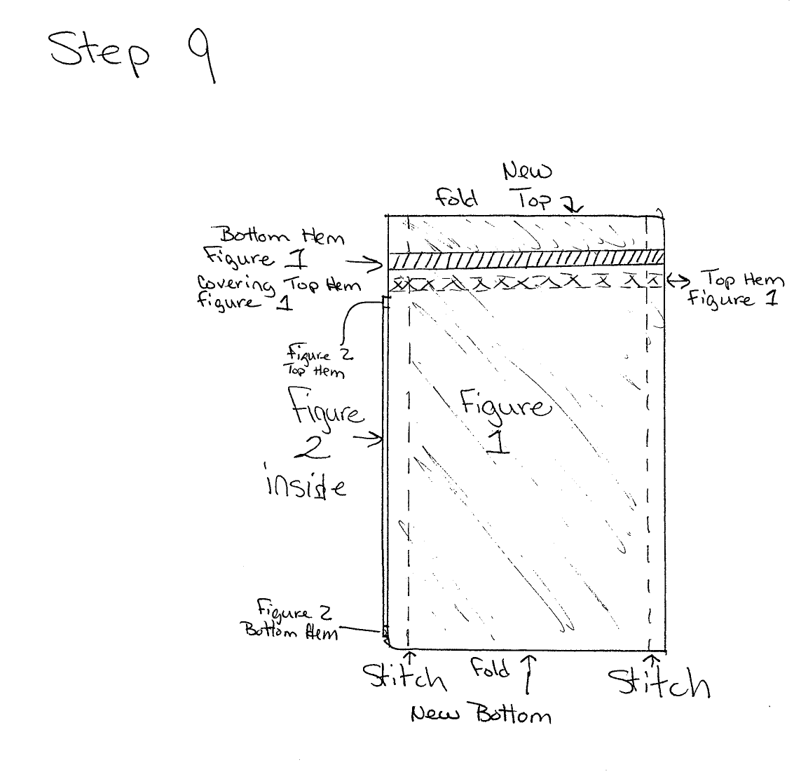

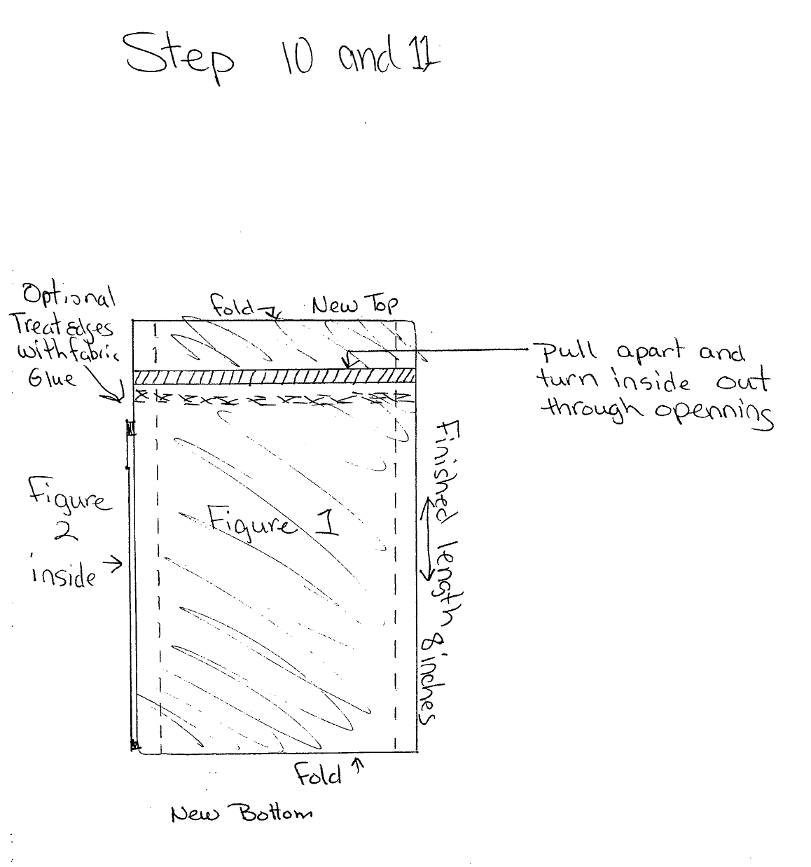

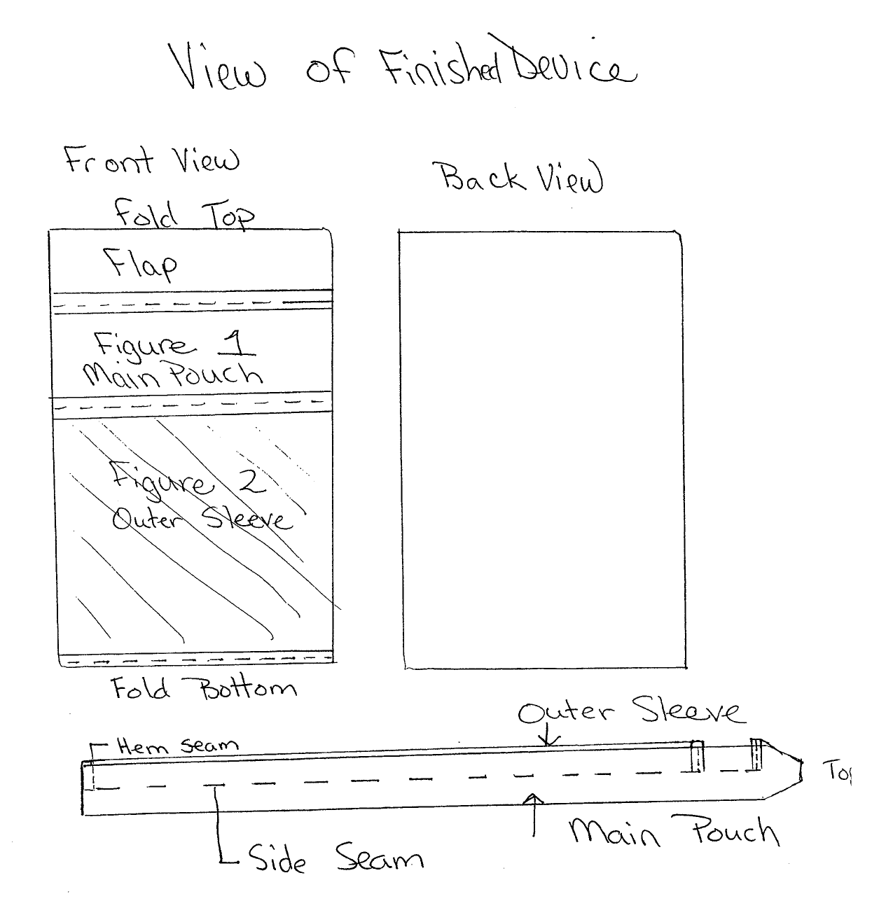

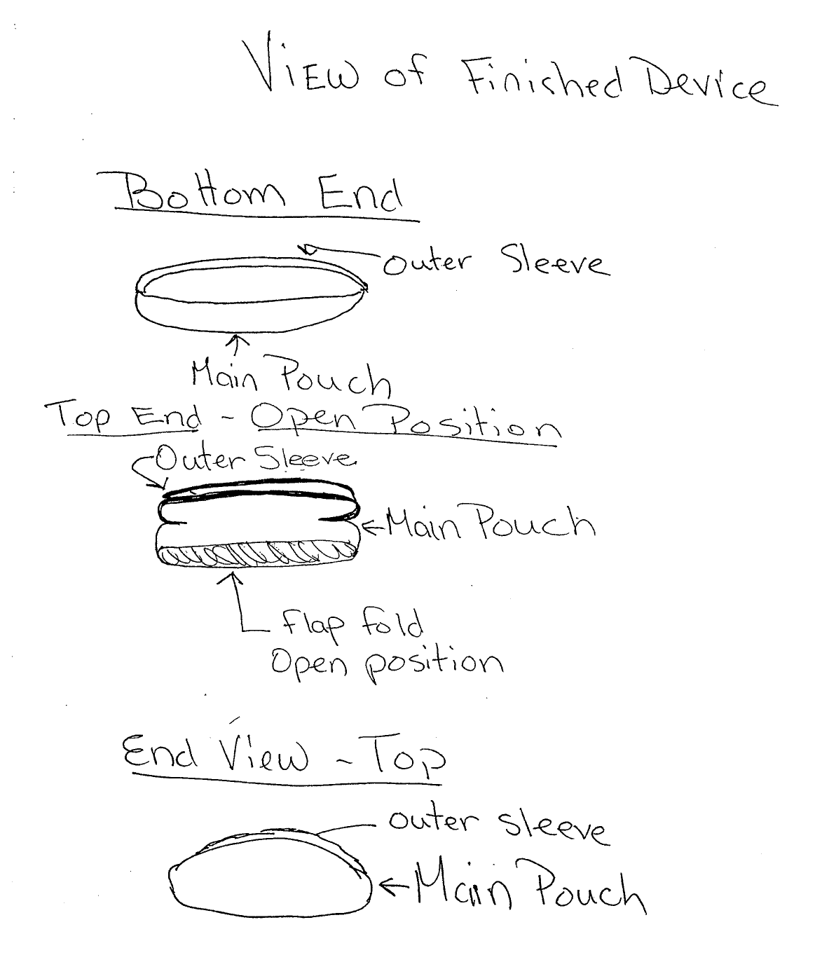

FIG. 1, when sewed correctly together with FIG. 2, is the main pouch to hold the self-contained warming/cooling medium. FIG. 2, when sewed together correctly with FIG. 1, is the sleeve used to insert the collar to hold the warming/cooling medium in place against the underside of the animal/pet/dog's neck.

All elements of the devise are necessary to hold the self contained cooling/warming medium, like a manufactured flexible ice cube, in the proper place on the underside of a pet/dog's neck. Additional elements like different colors, fabrics and trim could be added to make the devise more aesthetically pleasing. Slip covers could also be made for those pet/dog's sensitive to direct cold/heat being applied to their neck or for fashion and aesthetic reasons. The device could also be made in different sizes to accommodate a range of sizes of animal/pet/dogs.

### DETAILED DESCRIPTION OF DEVICE

FIG. 2 is placed on top of FIG. 1. FIG. 1 is then folded over and a seam is stitched down each side of the device to create the main pouch, cover flap and the collar sleeve.

The main pouch holds the self contained cooling/warming medium like manufactured flexible ice cubes. The outer sleeve allows the pet/dog's collar strap to slide through. The collar, when placed around the pet/dog's neck, holds the main pouch directly against the underside of the pet/dog's neck.

Step 1: Cut a strip of the rip stop fabric (or other soft fabric type) 18 inches long by 3 inches wide (FIG. 1). Step 2: Cut a strip of rip stop nylon fabric (or other soft fabric type) 7 inches long by 3 inches wide (FIG. 2). Step 3: Sew a small hem on both ends of FIG. 1. Step 4: Sew a small hem or serger stitch on both ends of FIG. 2: Step 5: Place the fabric described as FIG. 1 on a flat surface with the open hem edges face down. Step 6: Place the top edge of FIG. 2 with the open hem edges face up approximately 2½ inches from the top of FIG. 1. Step 7: Take the top hem of FIG. 1 and fold it down approximately 1 inch. Step 8: Take the bottom of hem of FIG. 1 and fold it up and over the top hem of FIG. 1 by approximately 1/2 inch. Pin in place. Step 9: Stitch along the length of FIGS. 1 and 2 as folded on each side lengthways. Step 10: Treat the edges of the fabric with fabric glue to prevent fraying (this step is optional). Step 11: Turn right side out so that the open hem edges face inside. Step 12: Insert a cooling/warming medium package in the pouch. Step 12: Fold over the flap. Step 13: Slip the collar through the outer sleeve so that the main pouch will rest on the inside of the collar and the sleeve will be visible on the outside of the collar. Step 14: Attach collar to pet/dog's neck.

The strips in FIGS. 1 and 2 can be cut in varying lengths to fit different sizes of neck areas for larger or small animals/pets/dogs. The sleeve width can be adjusted by stitching a smaller channel the length of FIG. 2 of the device after Step 6 and before Step 7.

Unfold the flap at the top of the device. Slide in a strip of cooling/warming self contained medium like flexible manufactured ice cubes until the strip is completely in the device. Fold over the flap. Remove pet/dog's collar from the animal/pet/dog's neck. Take one end of the animal/pet/dog's collar and insert it in the sleeve on the outside of the main pouch so that the main pouch runs along the inside of the animal/pet/dog's collar. Slide the collar completely through. Reattach collar around animal/pet/dog's neck. The main pouch should rest between the animal/pet/dog's neck and the animal/pet/dog's collar.

This device could be adapted for human use by sliding it through a neck strap or elastic type collar or headband for use when exercising or working in the hot sun or keeping warm in cold weather.

Adapt the device to fit around a person's neck to apply a frozen manufactured ice cube against the skin and assist with cooling off.

1. What I claim as my invention is a pouch for holding cooling/warming medium for use by animal/pets/dogs/animals to assist with body temperature regulation

2. The pouch of claim 1 which has a sleeve that can slide over an animal/pet/dog's collar to hold the pouch of claim 1 containing the cooling/warming medium to the underside of the animal/pet/dog's neck.

3. The pouch in claim 1 which contains at least one open end with a flap that can be folded over to enclose the cooling/warming medium firmly within the pouch in claim 1.
